(19) United States
(12) Patent Application Publication
(10) Pub. No.: US 2006/0294023 A1
(43) Pub. Date: Dec. 28, 2006

(54) System and method for secure online transactions using portable secure network devices

(76) Inventor: HongQian Karen Lu, Austin, TX (US)

Correspondence Address: ANDERSON & JANSSON L.L.P., 9501 N. CAPITAL OF TX HWY #202, AUSTIN, TX, 78759, US

(21) Appl. No.: 11/166,666

(22) Filed: Jun. 25, 2005

(51) Int. Cl. G06F 17/60

(52) U.S. Cl. 705/67

(57) ABSTRACT

A portable secure network device and method to operate such a device to provide secure login, secure online transactions, and to prevent online identity theft. An embodiment of the invention may be constructed by inserting a network smart card into a card reader, wherein either the card reader or the card itself has an output device and input device wherein the processor is programmed to execute according to instructions to cause the microprocessor: to produce a shared association secret; to display the shared association secret on the output device; and to transmit the shared association secret to the remote server; thereby ensuring that a user observing the output device and the remote server computer both possess the shared association secret.

### TECHNICAL FIELD

The present invention relates generally to online transactions and more particularly to systems and methods for performing secure online transactions using portable secure network devices.

### BACKGROUND OF THE INVENTION

Because of the advances in the capability of computers and widespread connections to computer networks, notably the Internet, many transactions that traditionally were performed person-to-person are now carried out remotely over such networks. These advances have been a great boon to many fields, such as online banking, e-commerce, online securities trading, the use of computers, and in particular, the use of computer networks has also facilitated what has become known as telecommuting, wherein employees connect via public networks to their employer's internal networks. While society may have benefited from these new uses of computers and computer networks, the access of computerized services over networks has also significantly increased risks. While security of personal and corporate data has been secured by the adoption of many security protocols and devices, e.g., encryption, secure protocols, and use of smart cards, these security mechanisms have seen attacks in many different forms. User authentication is one of the most vexing problems in the use of computerized devices.

Many of the traditional ways of providing user authentication are prone to various forms of attacks. The most common way of performing user authentication is to require a log in using a username and password combination. The user names and passwords may be misappropriated by methods such as keystroke logging, snooping, phishing, and even simply by having an unauthorized person read over a user's shoulder while the user is logging in to a secure system.

One recent advance in the art of computer networking is the introduction of network enabled smart cards. Network smart cards and their use are described in greater detail in co-pending and co-assigned U.S. patent application Ser. No. 10/848,738, entitled “SECURE NETWORKING USING A RESOURCE- CONSTRAINED DEVICE” by HongQian Karen Lu, Michael Andrew Montgomery, and Asad Mahboob Ali, the entire disclosure of which is incorporated herein by reference. Network smart cards are capable of access to Internet resources and to provide services over the Internet. At the same time, network smart cards face network security threats just like other computers on a network. One of the security problems is how to securely log into the network smart card through a network connection. Currently, the smart card contains a web server. The user accesses the card using a web browser and logs into the card using a Card Holder Verify (CHV), such as user name and password (or PIN) or biometrics. However, if an attacker has caught the smart card owner's CHV through some logging mechanism on the computer that the card owner used, he could use the appropriated credentials to log in to the card once the attacker has discovered where the card is located on the network.

One method of securing online transactions using the network smart card requires the card owner to remember a Shared Association Secret (SAS) for each remote service provider. That mechanism is described in co-pending and co-assigned U.S. patent application Ser. No. 10/750,430, entitled “SYSTEM AND METHOD FOR PREVENTING IDENTITY THEFT USING A SECURE COMPUTING DEVICE” of HongQian Karen Lu and Asad Mahboob Ali. The technique therein improves security over simply using a username and password scheme and provides end-to-end secure online transaction (i.e., it is not necessary to trust any of the computers between the network smart card and the remote host). However, the card owner must remember some extra items.

The most commonly used computer log in (with or without network) mechanisms, such as username/password, PIN, and even biometrics, are not very secure because under these methods, eavesdroppers may capture the user's input without the user's knowledge. One increasingly common mechanism to achieve better security relies on using a one-time password (OTP) in conjunction with a hardware token.

As its name indicates, the one-time password is used exactly once, after which it is no longer valid. OTP is a very strong defense against eavesdroppers, who might capture a user's input to the computers. There are various ways to implement one-time password systems. The most secure ways involve using hardware tokens or called handheld authenticators. There are several versions of the general OTP technique.

A first OTP technique, the time-based OTP, uses a clock and a secret key as the inputs to some function to compute the one-time password. The user holds a secure token, which has a secret key, an internal clock that is synchronized with the authentication server, and a display. The user may need to enter a PIN to use the secure token. The display shows some function of the current time and the secret key, which changes over time. The user enters the displayed value as the password to login to the server. The server consults with the authentication server to identify the user. The authentication server uses its copy of the secret key, the clock, and the same function to compute the response. If the response matches with the user's password, the authentication server confirms the user's identity. The function used for computing the response may be some cryptographic algorithm. The time-based OTP technique is described in Cheswick, W. R., Bellovin, S. M., and Rubin, A. D., “Firewalls and Internet Security, Second Edition,” Addison-Wesley, 2003.

Some OTP mechanisms use some kind of sequence number, such as a transaction number, instead of time. The basic method is similar to time-based OTP.

A second OTP technique, the challenge/response OTP, uses a non-repeating challenge from the authentication server. The response is a function of the challenge and a shared secret between the server and the client. The response may be computed by client software or a hardware token, or even by the user (in his mind). The hardware token is the strongest authentication tool. The user enters the PIN and the challenge to the token. The token computes the response from the challenge and the secret key; and displays the response as the password. Because no clock or sequence number involved, this method does not have synchronization problem of the time-based OTP technique. However, the challenge/response OTP technique requires the user to do a little more work to enter the challenge. Thus, the challenge/response OTP technique is a trade-off between security and convenience.

A third class of OTP techniques is used on smart cards to improve security. Examples of these techniques include offerings from Xiring Corporation of Suresnes, France (www.xiring.com) and Todos Data System AB of Göteborg Sweden (www.todos.se). These methods use a hardware token that is a smart card reader with a display and a keypad. The smart card is inserted into the token. The user may authenticate himself to the smart card by entering a PIN through the token. Rather than the token generating the OTP, the smart card generates the OTP, which is displayed on the token. The OTP may be generated using a sequence number based method or challenge/response based method. The user uses the OTP to login to the remote server.

The existing OTP mechanisms have several weaknesses, including the following.

1. Private keys are used for computing the OTPs. The OTP server maintains the private keys of its clients. The key databases are attractive targets for attackers.

2. The OTP methods typically require client and server synchronization. The mechanism fails to work when the client and the server are out of synchronization.

3. The OTP typically has a fixed length, and thus may be subject to authentication race attack on the last digit of the password.

From the foregoing it will be apparent that there is still a need for a way to provide increased security in user authentication for network based transactions.

### SUMMARY OF THE INVENTION

A preferred embodiment of the invention utilizes a portable secure network device that has a processor, an output device, and an input device, to provide secure login, secure online transactions, and to prevent online identity theft. An embodiment of the invention may be constructed by inserting a network smart card into a card reader, wherein either the card reader or the card itself has an output device and input device. In another alternative, a processor is embedded into a small device having an output device and input device. The processor may be programmed to execute according to instructions in a memory connected to the microprocessor wherein the memory comprises computer program instructions to cause the microprocessor: to produce a shared association secret; to display the shared association secret on the output device; and to transmit the shared association secret to the remote server; thereby ensuring that a user observing the output device and the remote server computer both possess the shared association secret.

Other aspects and advantages of the present invention will become apparent from the following detailed description, taken in conjunction with the accompanying drawings, illustrating by way of example the principles of the invention.

### BRIEF DESCRIPTION OF THE DRAWINGS

FIG. 1 is a schematic illustration of an example of an operating environment for a portable secure network device (PSND), in particular illustrating an example network connection.

FIG. 2a is a schematic illustration of a first alternative embodiment of a PSND according to the invention in which the PSND consists of a network smart card inserted into a small secure token that acts as a smart card reader

FIG. 2b is a schematic illustration of the PSND constructed by the insertion process illustrated in FIG. 2a.

FIG. 3a is a schematic illustration of alternative embodiment for creating a PSND consisting of inserting a network smart card into a secure token that acts as a smart card reader.

FIG. 3b is a schematic illustration showing the PSND wherein a network smart card has been inserted into the secure token according to the illustration of FIG. 3a.

FIG. 4 is a schematic illustration of yet another alternative embodiment, in which a PSND is a small secure personal device that has a display, an input component, a secure microprocessor chip, such as a smart card chip, and networking capability, for example through connectors to the smart card chip and suitable communications software programmed onto the smart card chip.

FIG. 5a is a schematic illustration of yet another alternative embodiment in which a PSND is created by inserting a network smart card having a smart card chip connected to an on-card display and an on-card input component into a small connector.

FIG. 5b is a schematic illustration showing the PSND constructed in the manner illustrated in FIG. 5a.

FIG. 6 is a flow-chart illustrating a two-phase authentication mechanism according to the invention in which a PSND is used for providing a one-time shared association secret.

FIG. 7 is a schematic illustration showing the physical configurations of used in one embodiment of the invention to secure transactions with a remote server.

FIG. 8 is a schematic illustration showing the logical network connections when using a network smart card to authenticate a user on a local host to a remote server and using the smart card to secure online transactions.

FIG. 9 is a schematic illustration of the technique used in co-pending patent application Ser. No. 10/750,430 to establish associations between the remote server, the network smart card, the web browser instances, and the user.

FIG. 10 is a schematic illustration of a method according to the invention for establishing an association between a remote server, a network smart card, a web browser instance used by a user to communicate to the remote server, and the user.

FIG. 11 is a timing sequence diagram illustrating the message flow between the various nodes, servers and browsers in FIG. 10.

FIG. 12 is a schematic illustration of an exemplary architecture of a network smart card as may be used in exemplary embodiments of the invention in conjunction with a secure token to implement a portable secure network device according to the invention.

FIG. 13 is a schematic illustration of a software architecture for a network smart card as may be used in exemplary embodiments of the invention.

### DETAILED DESCRIPTION OF THE INVENTION

In the following detailed description, reference is made to the accompanying drawings that show, by way of illustration, specific embodiments in which the invention may be practiced. These embodiments are described in sufficient detail to enable those skilled in the art to practice the invention. It is to be understood that the various embodiments of the invention, although different, are not necessarily mutually exclusive. For example, a particular feature, structure, or characteristic described herein in connection with one embodiment may be implemented within other embodiments without departing from the spirit and scope of the invention. In addition, it is to be understood that the location or arrangement of individual elements within each disclosed embodiment may be modified without departing from the spirit and scope of the invention. The following detailed description is, therefore, not to be taken in a limiting sense, and the scope of the present invention is defined only by the appended claims, appropriately interpreted, along with the full range of equivalents to which the claims are entitled. In the drawings, like numerals refer to the same or similar functionality throughout the several views.

As shown in the drawings for purposes of illustration, the invention is embodied in a novel system and method to provide secure login, secure online transactions, and to prevent online identity theft with enhanced security. The advantages of these methods and systems include the following:
1. The authentication of the user to his network smart card is locally done. Therefore, the authentication of the user is not subject to the network attack.
2. The user can securely login to the network smart card from the computer connected to the card using one-time password. If the smart card has a routable IP address, the user can securely and simultaneously login to the card from multiple computers connected to the smart card through the network.
3. From the one-time password (OTP) perspective, problems associated with existing one-time password mechanisms (key database protection, server/client synchronization, and race attack) are avoided.
4. Keystroke logging-based online identity theft is avoided with added security and convenience as compared to the previous method. The login is more secure, the SAS is one-time use only, and the user does not need to remember the SASs.

In one aspect, the invention is a small portable secure network device (PSND) that has a secure microprocessor chip (embedded or removable), secure networking capability, and small input and display components that may be used to perform secure authentication and log in functions. The input component may be a small keypad, may have a biometric sensor, or some other means. In the several alternative embodiments, a PSND may consist of one or multiple pieces. The PSND connects to the network through a host computer. The connection to the host computer may be wired, wireless, or direct contact. Examples of host computers include desktop computers, PDAs, and mobile devices.

Hardware Overview

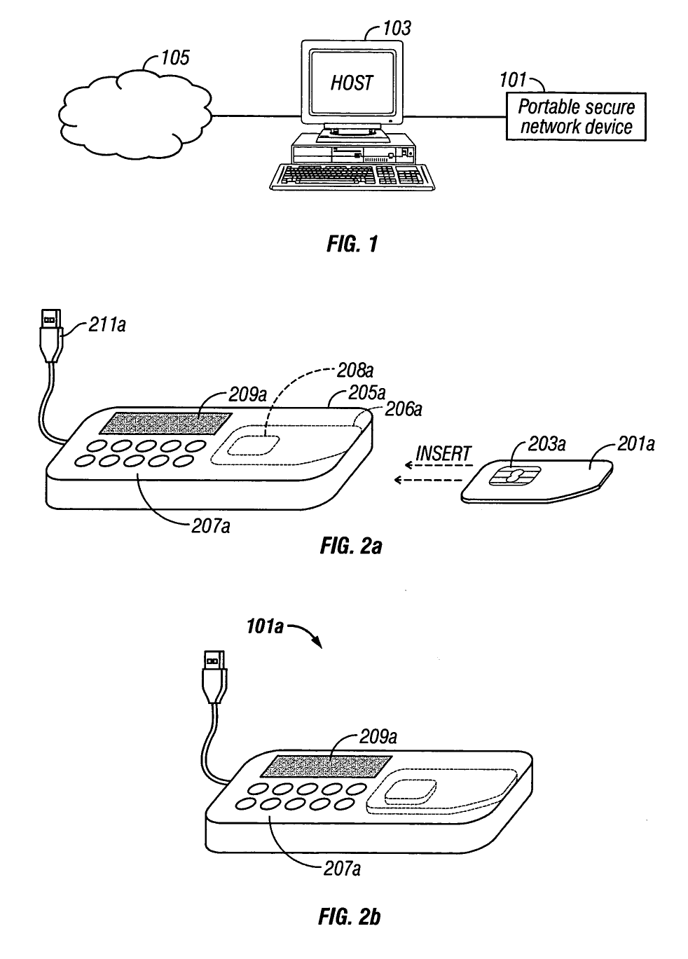

FIG. 1 is a schematic illustration of an example of an operating environment for a portable secure network device (PSND), in particular illustrating an example network connection. A portable secure network device 101 may be connected to a host computer 103 which in turn is connected to a network 105, e.g., the Internet.

In the discussion that follows a numbering scheme is employed in which different embodiments of like devices use the same reference number with a unique letter suffix. When the reference number is not used with a suffix it is intended to apply to all elements with that reference number regardless of suffix. For example, herein below the discussion describes different alternative embodiments of PSNDs 101 according to the invention. These various embodiments may be referred to as PSND 101a, 101b, etc. If a statement is made that a PSND 101 is used to perform a certain action, any one of these embodiments (and any equivalents thereto) may be used to perform such certain action.

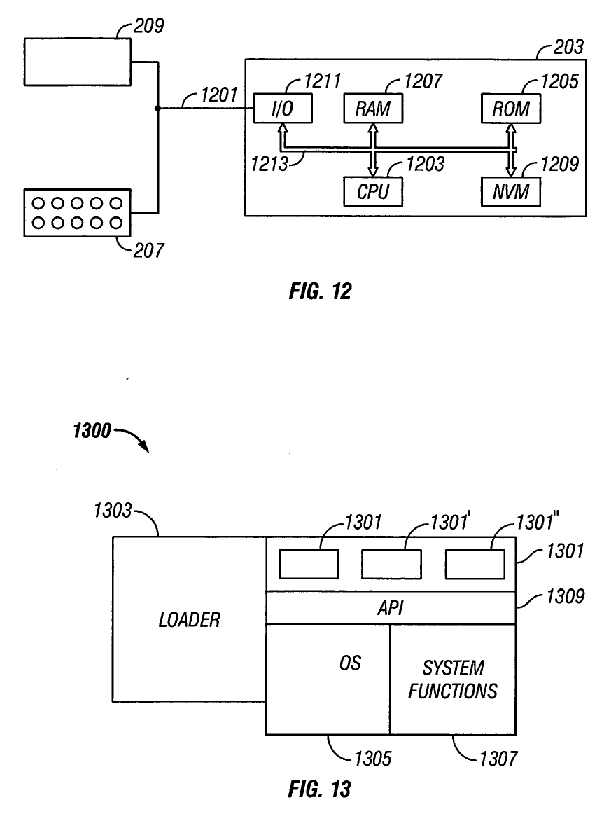

There are many alternative embodiments for implementing a PSND according to the invention. FIG. 2a is a schematic illustration of a first alternative embodiment of a PSND 101 according to the invention in which the PSND 101a consists of a network smart card 201a having a processor 203a inserted into a small secure token 205a that acts as a smart card reader, i.e., the secure token 205a has some form receptacle 206a into which the smart card 201a may be inserted to come into contact with a connector 208a of the secure token 205a. The processor 203a is illustrated using the visible portion of the electronic circuitry of a smart card 201a. As persons familiar with smart cards art know, this visible portion is in fact only the contact pads that are used to make contact with corresponding contacts in the smart card reader, e.g., in the present embodiment, the secure token 205a. The smart card processor also is composed of various electronic modules. These are further illustrated in FIG. 12.

FIG. 2b is a schematic illustration of the PSND 101a constructed by the insertion process illustrated in FIG. 2a.

The small secure token 205a has a display 209a and an input component 207a. The smart card 201a may be completely or partially inserted into the secure token 205a. A user may communicate with the smart card 201a (or more precisely with the smart card processor 203a) using the display 209a and input component 207a. The token 205a may be connected to a host computer 103 on the network 105. The secure token 205a further has a connector 211a for connecting the secure token 205a to a host computer 103. Alternatively, the secure token may communicate wirelessly, e.g., using the Bluetooth communications protocol, to the host computer.

In one alternative embodiment the network smart card 201a has a USB interface. The secure token 205a is a USB token. The network smart card 201a may have a SIM (Subscriber Identification Module) form factor (very small card) as used in many mobile telephones. The SIM-form factor network smart card 201a may be inserted into the token 205a, i.e., in this particular alternative embodiment, the token 205a is a USB connector for the network smart card 201a to connect to the host computer 103.

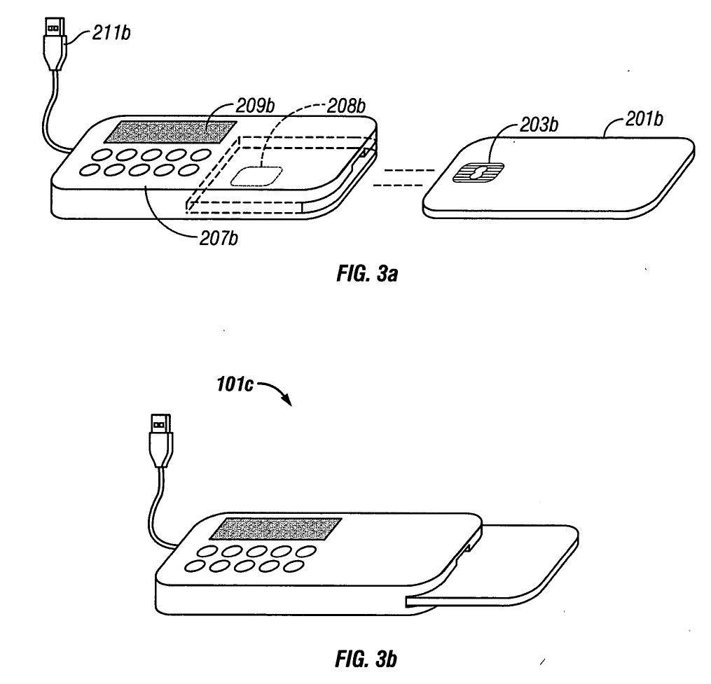

In alternative embodiments, the network smart card 201a, while being a small smart card form factor such that it may be inserted into the token 205a, the network smart card 201a is not necessarily a SIM card. In an alternative embodiment, the network smart card 201 may be a credit card form factor, as illustrated in FIG. 3. Furthermore, while USB has become a very popular standard for connecting a wide range of computer peripheral equipment to computers, other communication and connection standards may be used. Examples include standards used to connect memory cards to computers, Firewire, Near Field Communication (NFC) and serial communication.

FIG. 3a is a schematic illustration of another alternative embodiment of creating a PSND 101b consisting of inserting a network smart card 201b that is a standard ISO 7816 card into a secure token that acts as a smart card reader. In the case of the embodiment of FIGS. 3a, a secure token 205b is a smart card reader with a display 209b and an input component 207b, e.g., a keypad, and a connector 208b for making contact with a corresponding connector on the smart card 201b. The secure token 205b further has a connector 211b for connecting the secure token 205b to a host computer 103. Alternatively, the secure token 211b may communicate wirelessly, e.g., using the Bluetooth communications protocol, to the host computer 103. FIG. 3b is a schematic illustration showing the PSND 101b wherein the smart card 201b has been inserted into the secure token 205b in the manner illustrated in FIG. 3a.

Currently existing smart card readers with displays and keypads may serve as secure tokens 205b according to the invention with only minor modification to the device drivers of the tokens. The modification includes adding a small communication module to provide the communications capabilities that would allow an ISO 7816 smart card to act as a network peer. This software module is described in greater detail in the co-pending patent application U.S. patent application Ser. No. 10/848,738.

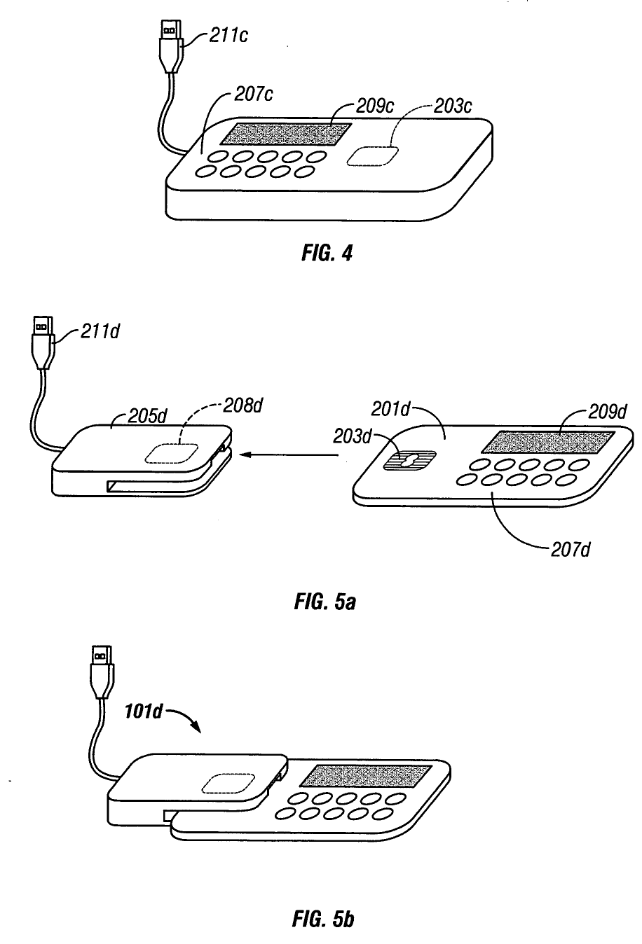

FIG. 4 is a schematic illustration of yet another alternative embodiment, in which a PSND 101c is a small secure personal device that has a display 209c, an input component 207c, a secure microprocessor chip 203c, such as a smart card chip, and networking capability, for example through connectors to the smart card chip and suitable communications software programmed onto the smart card chip. The PSND 101c further has a connector 211c for connecting the PSND 211c to a host computer 103. Alternatively, the PSND 211c may communicate wirelessly, e.g., using the Bluetooth communications protocol, to the host computer 103. The PSND 101c connects the network 105 by connecting to a host computer 103, as illustrated in FIG. 1. The Trusted Personal Device being developed by the European project Inspired is an example of this kind of device. The device may also be a USB token with a microprocessor chip, a display and a keypad.

FIG. 5a is a schematic illustration of yet another alternative embodiment in which a PSND 101 is created by inserting a network smart card 201d having a smart card chip 203d connected to an on-card display 209d and an on-card input component 207d into a small card connector 205d. The smart card 501 connects to the network 105 by connecting to a host computer 103 through the small card connector 205d. The small card connector 205d further has a connector 211d for connecting the small card connector 205d to a host computer 103. Alternatively, the small card connector 205d may communicate wirelessly, e.g., using the Bluetooth communications protocol, to the host computer 103. FIG. 5b is a schematic illustration showing a PSND 101d constructed in the manner illustrated in FIG. 5a.

FIGS. 2 through 5 illustrate input components 207 as keypads. In alternative embodiments, the input can be through other means, such as voice input. Other alternatives include biometric sensors. For convenience, in the following description, we use the term smart card or network smart card to represent the network smart card or the secure microprocessor chip inside the PSND 101.

Existing hardware, including high-end smart card readers, secure tokens, and USB tokens, demonstrate the feasibility of constructing the hardware token provided for by the invention. However, none of the existing hardware or their drivers (if the hardware is to connect to a host computer) can be used directly without the modifications described herein.

Smart card readers enable smart cards to connect to host computers. High-end smart card readers have keypads and even small displays. These kinds of readers are typically used in banking. Users can be locally authenticated to their smart cards through the readers.

A variety of security tokens are on the market. Many of these are used to generate OTP. Some security tokens are battery-powered stand-alone tokens, which do not connect to a computer. Some are USB tokens, i.e., they connect to computers through USB interface. Some security tokens have a small display and a few buttons (or a small keypad), for example, for entering PIN and display OTP.

Method for User Authentication

The input component 207 of a PSND 101 according to the invention enables users to enter the Card Holder Verification (CHV) thereby authenticating the user locally to the smart card processor 203. Examples of CHV include the PIN, voice and biometrics. The user authentication to the smart card processor 203 via CHV is local, which prevents the network attacks. Using PIN as local authentication has been used in banking successfully. The method described herein below extends the method to authenticate users to their network smart cards.

Secure Access

A network smart card 203 contains a secure web server or a secure web agent. To access the network smart card 203 or to conduct a secure online transaction, the user connects the PSND 101 to the network 105 through a host computer 103 and the smart card 203 first authenticates the user locally (i.e., without involvement of any other devices) and next authenticates the user via the host computer which the user is using.

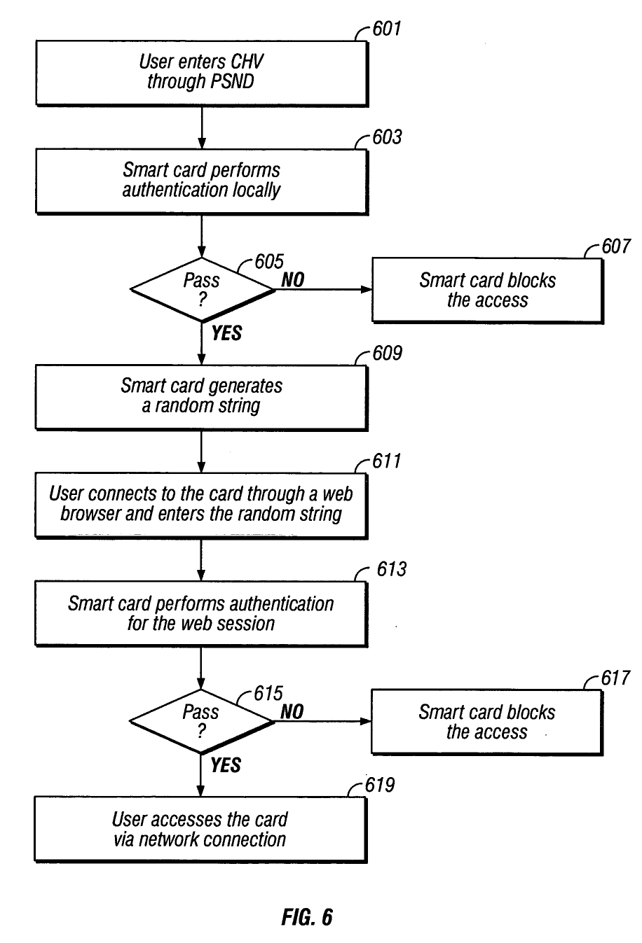

FIG. 6 is a flow-chart illustrating this two-phase authentication mechanism. The user enters a CHV through the input device 207 of the PSND 101 that may be part of the token 205 or part of the card 201, step 601, and the smart card 203 performs an authentication based on the entered CHV, step 603. If the user does not pass the authentication, step 605, i.e., fails to enter the correct CHV (perhaps after being given a certain number of opportunities to do so), the smart card 203 blocks further access, step 607.

If the user does pass, step 605, the smart card 203 (or the secure microprocessor chip) generates a random string with a random length, step 609, which serves as a one-time password. The one-time password is displayed on the PSND for the user to see on the display 209. The user starts a web browser instance on the host 105 and connects to the smart card 203 via this web browser instance, step 611. The web server on the smart card 203 generates a webpage with a prompt requiring the user to enter the random string and transmits this webpage with a prompt to a web browser instance on the host 105 to which the smart card 203 is connected. In response to the prompt being displayed on the host computer 103, the user enters the password from the host computer to log into the web server of the smart card through the web browser on the host computer. The smart card 203 authenticates the user based on correct entry of the one-time password, step 613. If the user fails to enter the correct one-time password, step 615, the smart card 203 blocks further access, step 617. Otherwise, once accepted, the user can access the network smart card via the web browser or other Internet applications, step 619.

The user can access the network smart card 203 from computers other than the host computer 103 on the same network 105 as well, if the smart card 203 has a routable IP address within the network 105. In this case, the network 105 is typically a local network. The user may access the smart card 203 from more than one computer simultaneously, for example, from a laptop and a PDA. For each network access, the user asks the smart card to generate a random string and displays it on the PSND. The random string is the one-time password for a particular connection to the smart card through the network.

Secure Online Transactions

In one embodiment of the invention, a PSND 101 may be employed in a method of using network smart cards to prevent online identity theft and to secure Internet online transactions. The method builds upon the methods described in co-pending and co-assigned patent application Ser. No. 10/750,430, the entire disclosure of which is incorporated herein by reference. The security functions are provided by the network smart card 203, i.e., the secure microprocessor chip 203 inside the PSND 101, which may have been inserted into the token 205 as a separate smart card or permanently installed as a microprocessor chip 203, e.g., as shown in FIG. 4.

One of the online identity theft methods is logging, in which a spyware program logs a user's keystrokes or the screen without the user's knowledge. The log file is either retrieved later by the attacker or is sent automatically and periodically to the attacker's machine through the Internet. The attacker then extracts sensitive personal information from the log file and uses the information to conduct security frauds or other damage to his victims. This kind of attack is possible because unencrypted confidential information is present in the computer for some duration, however small. The attacker could gain access to this information before any security mechanism is applied. The logging mechanism will not work, if the confidential information never appears in clear format in the computer. This is one of the concepts disclosed in co-assigned patent application Ser. No. 10/750,430.

According to the invention, the network smart card 203 is used to store confidential personal information. When needed and authorized by the owner during an online transaction, the information flows securely from the card to the remote Internet client or server. The encryption and decryption happen inside the smart card. Although the information still passes through the computer used for the online transaction, the information is encrypted and, hence, secure from theft, for example, by logging. From the network's perspective, the user's computer is just another router on the network.

FIG. 7 is a schematic illustration showing the physical configurations used in one embodiment of the invention to secure transactions with a remote server. The remote server executes on a remote computer 701 connected to the Internet 703. The network smart card 203 is connected to the Internet 705 through a connection to the local computer 705, which is also connected the Internet 705. The user uses the local computer 705 to access the network smart card 203 and the Internet for secure online transactions.

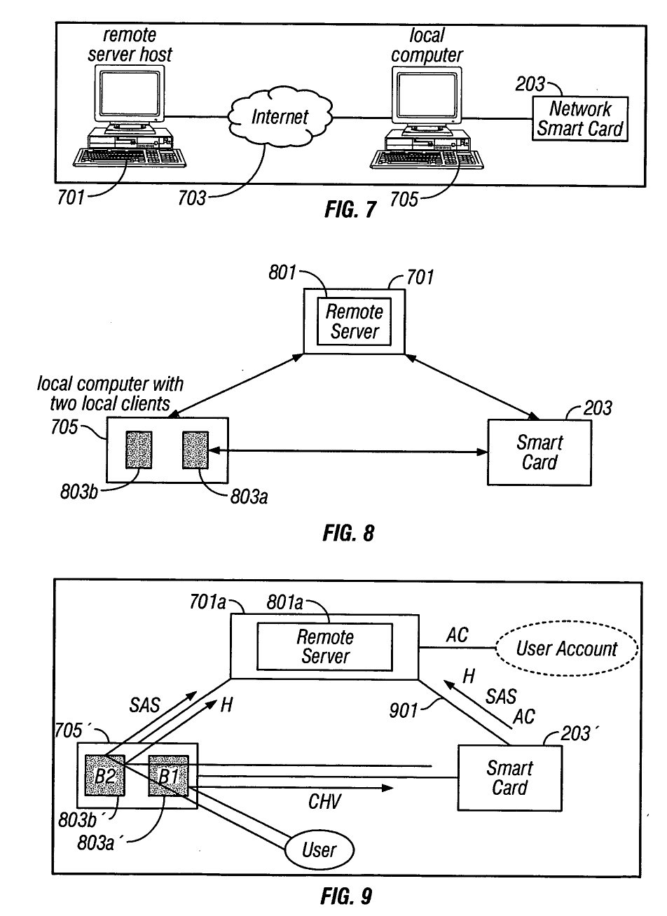

FIG. 8 is a schematic illustration showing the logical network connections when using a network smart card to authenticate a user on a local host to a remote server and to conduct secure online transactions. The local computer 705, the remote server host 701, on which the remote server 801 executes, and the network smart card 203 are all Internet nodes. On the local computer 705, the user uses two web browser instances 803a and 803b (or two web folders, frames or tabs of one browser—these alternatives are all encompassed by the use of the term web browser instance herein): one web browser instance connects to the network smart card 203, and the other connects to the remote server 801. The smart card 203 also has a direct connection with the remote server 701. All connections illustrated and described in conjunction with FIG. 8 represent secure network connections using, for example, SSL or TLS.

To conduct a secure online transaction, the user logs into his smart card through the first browser instance B1. He then establishes a secure Internet connection between his smart card and the remote secure server of a service provider, for example, a bank. Through a second web browser instance, the user connects to the remote server. When interacting with the server's web page, the user decides which information is entered manually and which information the smart card sends directly to the server. Non-critical information can still be typed in the browser manually and sent to the remote server, if so desired. However, all confidential information flows securely and directly from the network smart card to the remote server.

This mechanism applies to all kinds of online transactions; for example, creating a new account and accessing an existing account. The card owner determines the kind of personal information kept inside the network smart card 203. For example, the network smart card 203 may hold passwords, SSN, and credit card numbers. Because the information is encrypted/decrypted inside the network smart card 203 or inside the remote secure server host 701, the information is concealed from the user's local computer 705. Keystroke logging or other logging mechanisms cannot be used to obtain the information.

Features of this mechanism include establishing a secure Internet connection between the smart card and the remote server of a service provider and sending encrypted information between the card and the server directly via the secure connection. This method is not limited to the form of secure network smart cards. It also applies to other secure tokens that are Internet nodes and wherein the security boundary is located inside the tokens, i.e., the secure communications channel is established from the token and messages are sent encrypted from the token to whatever remote destination with which the token is communicating.

Associations

One major difficulty of the method described above is for the remote server to associate the user, the web session between the web browser instance by which the local computer 705 is connected to the remote server 801, e.g., the web browser instance B2 803b, and the user's network smart card 203. Establishing this three-way association is non-trivial because the smart card 203 and the local computer 705 that hosts web browser instance B2 803b are two different Internet nodes. The co-pending patent application Ser. No. 10/750,430 describes using a hash value H and the Shared Association Secret (SAS) to resolve the association.

FIG. 9 is a schematic illustration of the technique used in co-pending patent application Ser. No. 10/750,430 to establish the association between the remote server, the network smart card, and the second web browser instance.

The user connects to his smart card 203′ through the web browser B1 803a′ and logs into his smart card 203′ web server using his CHV. When the user wants to connect to a remote server 801a of a service provider over the Internet 703, he clicks the link (or enters an appropriate URL) for the remote server 801a from the first web browser instance B1 803a′. Two things result. First, the smart card 203′ establishes a secure connection 901 with the remote server 801a and securely sends a hash value H of some random number, a SAS, and optionally the account credential AC if the user has an account with the remote server 801a. Second, a second web browser B2 803b′ starts up connecting to the remote server 801a with the hash value H as a parameter. Starting the second web browser instance 803b′ may be performed by the action taken in clicking the connection link in web browser B1 803a′. The remote server 801a uses H to associate B2 and the smart card 203′. In response to the connection request from web browser instance B2 803b′, the remote server 801a sends a login page to the second web browser instance B2 803b′. At the login prompt of the remote server's web page displayed in the second web browser instance B2 803b′, the user enters the SAS. The remote server 801a uses the SAS to associate the user with the smart card 203′ (by virtue of having received the same hash value H and the same SAS from the smart card 203′) and the user's account, if the account credential was sent by the smart card earlier. This mechanism is described in greater detail in co-pending patent application Ser. No. 10/750,430.

The remote server 801a keeps the SAS for one session only. The user-client-card association that includes the SAS is removed from the remote server 801a at the conclusion of the session. For security, this SAS should be different from the smart card CHV that the user uses to login to the network smart card 203′. For added security, the user can use different SASs for different service providers and change the SAS often. This security, however, adds inconvenience to the user because he has to remember one or more SASs and remember to change the SAS to keep the security level high.

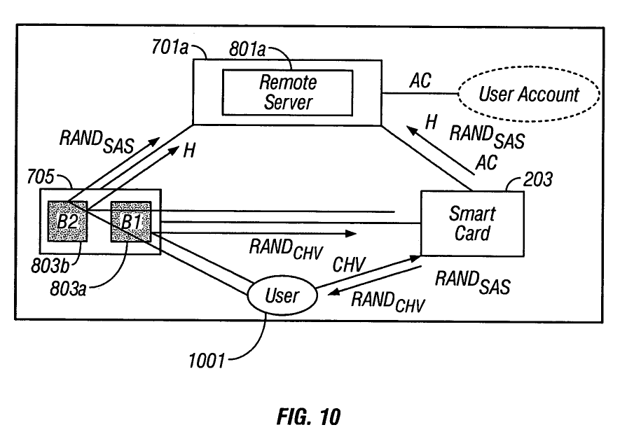

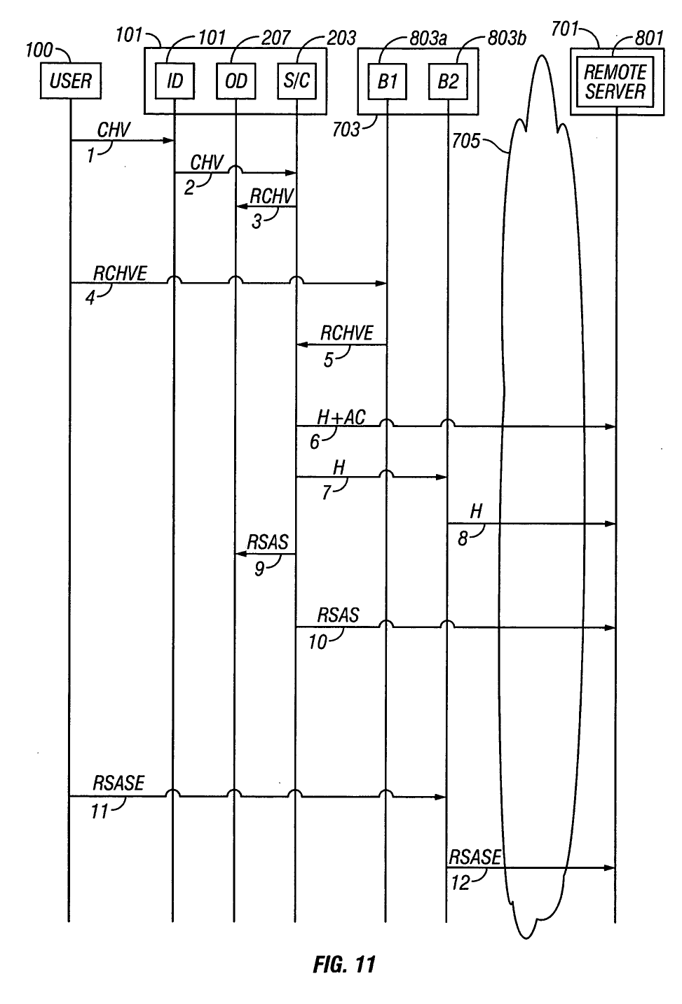

One aspect of the invention uses a PSND 101 to solve the problem of providing an association between the user, the local host client, and the network smart card without requiring the user to remember a shared association secret. One exemplary embodiment of that aspect of the invention is illustrated and described in conjunction with FIGS. 10 and 11.

FIG. 10 is a schematic illustration of a method according to the invention for establishing an association between a remote server, a network smart card, and a web browser instance used by a user to communicate to the remote server.

Instead of using a fixed SAS for each remote service provider and having the user to remember the SAS, the network smart card 203 generates a random string of a random length as a SAS (RAND_{SAS}). The smart card 203 is located inside a PSND 101 as described in conjunction with FIGS. 2 through 5, or any equivalent thereto. The PSND 101 displays the SAS on the display device 209. To secure online transactions, the network smart card 203 sends the SAS to the remote server 801 together with other information, e.g., account information. The user 1001 enters the SAS to the second web browser B2 803b, which connects to the remote server 801, to associate the user through the second web browser B2 803b to the session established between the network smart card 203 and the remote server 801.

FIG. 11 is a timing sequence diagram illustrating the message flow between the various nodes, servers and browsers in FIG. 10. A user 1001 seeks to use the PSDN 101 to authenticate himself with a remote server 801 and to secure online transactions. As noted above in the discussion in conjunction with FIGS. 2 through 5, a PSDN 101 is composed of a smart card 203 and an input device 207 and an output device 209. As an initial step the user authenticates himself with the PSDN by entering a CHV on the input device, step 1. The input device transmits this internally in the PSDN to the smart card 203, step 2. If the user has successfully entered the correct CHV, the smart card 203 computes a random number RAND_{CHV} (RCHV in FIG. 11) and displays that number on the output device 209, step 3.

Having observed the RAND_{CHV} on the display 209, the user enters the RAND_{CHV} in the first web browser instance B1 803a, step 4. The web browser instance B1 803a then sends the entered (RCHVE in FIG. 11) to the smart card 203, step 5. The card then compares the entered RAND_{CHV} against the actual RAND_{CHV} that the smart card 203 had generated. If there is a mismatch, the smart card shuts down the process of authenticating the user.

If, however, the entered RAND_{CHV} and the actual RAND_{CHV} match, the user is authenticated through web browser instance B1 803a, from which the user can access and interact with the smart card 203. The smart card 203 proceeds with authenticating the user 1001 to the remote server 801 when the user wants to connect to remote server 801. The smart card 203 starts this second phase with establishing a secure connection to the remote server 801 and transmits on this secure connection a match value H and any account information AC to the remote server 801, step 6. The smart card 203 also sends the match value H to a second browser instance B2 803b, step 7. Upon receiving the match value H from the smart card 803b, the second browser instance B2 803b sends the match value H to the remote server 801 together with a getting web page request, step 8. The match value H allows the remote server to make an association between a smart card 203 and the second web browser session B2 803b.

Next the smart card 203 generates another random number (RAND_{SAS}) which is used to authenticate the user to the remote server 801 through the web browser instance B2 803b. RAND_{SAS} is used to assure the remote server 801 that the person holding the PSDN 101 (and therefore the smart card 203) is the same person as the person operating the second web browser instance 803b. The smart card 203 transmits the RAND_{SAS} (labeled RSAS in FIG. 11) number to the display 209, step 9, and to the remote server 801, step 10.

The user 1001, being able to read the RAND_{SAS} number on display 209, enters it where prompted to do so on the remote server's web page displayed on the second web browser instance 803b, step 11. The second web browser instance 803b then forwards the entered RAND_{SAS} number (RSASE) to the remote server 801, step 12. At this point the remote server 801 compares the entered RAND_{SAS} number with the actual RAND_{SAS} number provided by the smart card 203. Because the smart card 203 had transmitted the same number to the remote server 801 as that which is being displayed on the PSND 101 display 209, it may be deduced that the person operating the second web browser instance B2 803b is the same person as the person authorized to have information transmitted from the smart card 203. Accordingly, the remote server 801 can safely allow the user of the second web browser instance to have access to accounts or transactions authorized by the smart card 203.

This method is more secure and more convenient. The RAND_{SAS} shared secret acts as a one-time password for the user 1001 to login to the remote server 801. The remote server 801 does not need to generate nor synchronize with any device for this one-time password. Furthermore, the user does not need to remember the SAS.

Security Analysis

A Portable Secure Network Devices (PSND) 101 may be used according to the invention to allow users to securely login to a network smart card over a network, to prevent online identity theft, and to secure online transactions. The authentication of the user to the network smart card is local, which prevents network attacks. These techniques combat online identity theft mechanisms that capture information on the computer before the information is encrypted. Some embodiments establish a secure connection between a smart card (or the microprocessor chip inside PSND) and a remote Internet node. This end-to-end secure connection enables the smart card and the remote server to exchange confidential information securely and directly. Any intermediate node, including the host computer to which the PSND is connected, cannot compromise this secure connection because the information is encrypted and decrypted inside the smart card and the remote server.

The two random strings generated by the smart card RAND_{SAS} and RAND_{CHV} and displayed on the PSND are used as one-time passwords to authenticate and to associate the user to the secure web server inside the smart card and to the remote service provider through the network. These random strings are only used once. Even if caught, they have no further value and cannot be used to obtain authorization for either the smart card or the remote server. The random length prevents race attacks.

### ADVANTAGES

From the foregoing it will be appreciated that a system and method for providing secure login provided by the invention provides an efficient and secure way to securely login to a network smart card over a network, to prevent online identity theft, and to secure online transactions. The advantages of the systems and methods provided for by the invention include, but is not necessarily limited to, the following.

1. The authentication of the user to a network smart card is locally done through PSND. Therefore, it does not subject to network attacks.

2. The user can securely login to the network smart card from the computer connected to the smart card. If the smart card has a routable IP address, the user can securely and simultaneously login to the card from multiple computers connected to the smart card through the network.

3. From the one-time password (OTP) perspective, the system and methods provided for by the invention overcome three problems associated with existing one-time password mechanisms: key database, server/client synchronization, and race attack. With a typical OTP method, the server keeps the secret keys of its clients. The key database is an attractive target for attackers and hackers. Many OTP methods are time based or sequence based, with which the client and server synchronize using time or a number sequence. Problems occur when the client and server are out of synchronization. Existing OTP methods use fixed length passwords, which are susceptible to race attacks. With the systems and methods provided for by the invention, the remote server does not maintain the key database nor does it synchronize with any other nodes or devices for the OTP, because the OTP is generated by the smart card and is sent securely from the smart card to the remote server. The one-time password (random string) generated by the smart card is of random length, which combats the race attack.

4. The methods and systems provided for by the invention secure online transactions and prevent logging based online identity thefts with added security and convenience as compared to the previous method. The login is more secure, the SAS is one-time use only, and the user does not need to remember the SASs.

FIG. 12 is a schematic illustration of an exemplary architecture of a network smart card processor 203 and further illustrating the connections formed when such a processor is connected with a display device 209 and an input device 207 to create an implementation of a portable secure network device 101 according to the invention. The smart card processor 203 has a central processing unit 1203, a read-only memory (ROM) 1205, a random access memory (RAM) 1207, a non-volatile memory (NVM) 1209, and a communications interface 1211 for receiving input and placing output to a device, e.g., the secure token 205, to which the smart card processor 203 is connected. These various components are connected to one another, for example, by bus 1213. In one embodiment of the invention, the on-card software used to implement the methods described herein may be stored on the smart card 203 in the ROM 1205. During operation, the CPU 1203 operates according to instructions in the various software modules stored in the ROM 1205.

The smart card processor 203 is connected to the display device 209 and the input device 207, for example, by placing the contact pad on the card in contact with the contact pad 208 of FIGS. 2, 3, and 5, or by being directly wired, as would be the case of the implementation illustrated in FIG. 4.

FIG. 13 is a block diagram of an exemplary software architecture 1300 that one may find implemented on a smart card 101. The software architecture 1300 includes several application programs 1301, e.g., application programs 1301, 1301′, and 1301″. These are loaded onto the smart card by a loader 1303. The application programs 1301 would typically be loaded into the non-volatile memory 1209. However, in other scenarios an application program may be permanently written onto the smart card at manufacture by having it stored in the ROM 1205.

In one embodiment, the application programs 1301 are compiled into executable code. The job control is managed by some operating system program 1305.

In most embodiments of the invention, the smart card software architecture 1300 also includes some system functions 1307. System functions 1307 may include security functionality, cryptography functionality, and utility libraries which may be called by application programs 1301. Typically, the methods for the on-card functionality described herein would be part of the systems functions 1307.

Although specific embodiments of the invention have been described and illustrated, the invention is not to be limited to the specific forms or arrangements of parts so described and illustrated. The invention is limited only by the claims.

I claim:

1. A portable secure network device (PSND) for conducting secure transactions between a local computer and a remote server computer connected over a network, comprising:
a microprocessor;
an output device connected to the microprocessor;
a memory connected to the microprocessor wherein the memory comprises computer program instructions to cause the microprocessor:
to produce a shared association secret;
to display the shared association secret on the output device; and
to transmit the shared association secret to the remote server;
thereby ensuring that a user observing the output device and the remote server computer both possess the shared association secret.

2. The portable secure network device of claim 1, further comprising:
an input device connected to the microprocessor;
wherein the memory further comprises instructions to cause the microprocessor to receive a card holder verification (CHV) phrase entered by a user on the input device, and instructions to deny the user access services requiring authentication by the PSND unless the user enters a correct CHV.

3. The portable secure network device of claim 2, wherein the CHV is selected from the set including personal identification number (PIN), password, and biometric input.

4. The portable secure network device of claim 1, wherein the memory further comprises computer program instructions:
to cause the microprocessor to display a card-holder-verification shared secret on the output device;
to receive a user attempt of entering the card-holder-verification shared secret on the local computer;
whereby the microprocessor can thereby verify that the user operating the PSND and the user operating the local computer are the same person.

5. The portable secure network device of claim 1, wherein the memory further comprises computer program instructions:
to cause the microprocessor to transmit a match value (H) to the local computer and to a remote server whereby the remote server, upon receipt of the match value from both the microprocessor and the local computer, can match up transactions commenced on the local computer with transactions to be authenticated using the portable secure network device.

6. The portable secure network device of claim 1 wherein the memory further comprises computer program instructions:
to cause the microprocessor to establish a secure communications channel between the portable secure network device and the remote server and wherein the instructions to transmit the shared association secret utilize the secure communications channel to transmit the shared association secret.

7. The portable secure network device of claim 6 wherein the memory further comprises computer program instructions:
to cause the PSND to securely transmit sensitive information stored on the PSND to the remote server over the secure communication channel from the PSND to the remote server when needed and authorized by the user.

8. A method of operating a local computer, a remote server, and a portable secure network device to establish secure transactions between a user and a service executing on the remote server, comprising:
authenticating the user to the portable secure network device via card holder verification (CHV);
operating a first browser on the local computer to establish a connection between the user and the portable secure network device;
operating the portable secure network device to compute a card-holder-verification shared secret, a shared association secret, and a match value;
displaying the card-holder-verification shared secret on an output device of the portable secure network device and prompting the user to enter the card-holder-verification shared secret in the first browser of the local computer, thereby verifying that the user operating the local computer is the same person as the user operating the portable secure network device;
operating the portable secure network device to establish a secure connection to the remote server and to transmit on the secure connection a match value and the shared association secret to the remote server;
operating a second browser on the local computer to establish a connection between the user and the remote server;
operating the portable secure network device to transmit the match value to the second browser and operating the second browser to transmit the match value (H) to the remote server;
operating the remote server to associate the communications session from the PSND and the communications session from the second browser based on the identical mach value received from both the second browser and the PSND;
operating the portable secure network device to display the shared association secret on the output device;
operating the second browser to receive an input of the shared association secret from the user and to transmit the shared association secret to the remote server;
operating the remote server to authorize a transaction when remote server has received the correct shared association secret from the second browser.

9. The method of claim 8 wherein the card-holder-verification shared secret and the shared association secret are random numbers valid for only one session.

10. The method of claim 8 wherein the connection from the PSND to the remote server is a secure communications channel.

11. The method of claim 8 wherein the connection from the second browser to the remote server is a secure communications channel.

12. The method of claim 8 wherein the connection from the first browser to the PSND is a secure communication channel.

13. The method of claim 12, further comprising:
operating the PSND to securely transmit sensitive information stored on the PSND to the remote server over the secure communication channel from the PSND to the remote server when needed and authorized by the user.

14. A method of operating a local computer, a remote server, and a portable secure network device (PSND) to establish a secure transaction between a user and a service executing on the remote server, comprising:
generating an authorization one-time password on the portable secure network device;
displaying the authorization one-time password on an output device on the portable secure network device;
transmitting the authorization one-time password from the portable secure network device to the remote server using a secure communications link;
operating the local computer to receive an input of the authorization one-time password from the user and transmitting the user entry of the authorization one-time password to the remote server;
operating the remote server to authorize a transaction if the user entry matches the authorization one-time password received from the portable secure network device.

15. The method of claim 14 further comprising:
operating the PSND to require user authentication using an input device on the PSND.

16. The method of claim 14 further comprising:
operating the PSND to generate a card-holder-verification one-time password for authenticating a user of a local computer to commence secure transactions protected via the PSND;
operating the PSND to display the card-holder-verification one-time password on an output device of the PSND;
operating a browser on the local computer to require the user to enter the card-holder-verification one-time password and to receive an attempted card-holder-verification one-time password from the browser; and
operating the PSND to accept the user of the browser as an authorized user of the PSND if the attempted card-holder-verification one-time password matches the generated card-holder-verification one-time password.

17. The method of claim 14 further comprising the step of establishing secure communication channels from the PSND to the remote server and from the local computer to the remote server.

18. The method of claim 17, further comprising:
operating the PSND to securely transmit sensitive information stored on the PSND to the remote server over the secure communication channel from the PSND to the remote server when needed and authorized by the user.

19. A network smart card for insertion into a secure token having a display and an input device, the network smart card programmed with logic operable:
to cause an authorization random number to be displayed on the display; and
to transmit the authorization random number to a remote server over a secure communications channel;
whereby the remote server can authenticate a user of the network connected computer by comparing an entry of the authorization random number on a web browser instance on a network connected computer and the authorization random number as received from the network smart card.
